(19) United States
(12) Patent Application Publication
(10) Pub. No.: US 2026/0059022 A1
(43) Pub. Date: Feb. 26, 2026

(54) SYSTEM AND METHOD TO AUTO-PROVISION CASE CENTRIC SAAS APPLICATIONS

(71) Applicant: OPEN TEXT HOLDINGS, INC., Menlo Park, CA (US)

(72) Inventors: Srirama Chandra Akella, Hyderabad (IN); Vijaya Surya Kameswara Naga Srikanth Parimi, Hyderabad (IN); Bismita Mohanty, Hyderabad (IN); Sasanka Reddy Kanamatha Reddy, Chintalapudi Mandal (IN)

(21) Appl. No.: 18/812,735

(22) Filed: Aug. 22, 2024

(51) Int. Cl. H04L 67/51; H04L 67/00

(52) U.S. Cl. CPC H04L 67/51; H04L 67/34

(57) ABSTRACT

Systems and methods for use in a case management system environment are provided. Various embodiments of the present technology provide systems and methods relating to a no-code integrated and unified case management workspace. In some embodiments, a case management system provides a generic and flexible no-code solution that allows users to build end-to-end tailored case apps using several utilities and productivity tools. In one example, a case model is created and published. After a case config creation, a case application is generated, based on the created case model.

### TECHNICAL FIELD

This disclosure relates generally to case management in a distributed networked computing environment. More particularly, embodiments of this disclosure relate to a unified and integrated case management workspace with a no-code application builder.

### BACKGROUND

Case management systems, software, and/or cloud-based or other electronically-provided case management services (collectively, “case management systems”) are used to automate the management of complex sets of documents or other content and associated business or other processes, particularly in situations in which the documents or other content that may need to be managed for respective particular instances of a case model/type (e.g., a loan application) may not be the same for each instance and the processing required and/or selected to be performed may not be the same for each instance.

A case model typically describes a type of case, instances of which are to be managed by a case management system. As opposed to a very structured business process that defines a predetermined workflow that does not vary from instance to instance, using a case model one can model ad hoc actions and define responses thereto with mini workflows, enabling the processing of respective instances of a case model to be determined dynamically at runtime based, e.g., on events, context data, user input, dynamic evaluation of documents or other content, etc. As a result, each instance of a case model (e.g., the respective loan applications of different applicants) may follow its own course as determined at each step by processing as defined in applicable portions of the case model.

### SUMMARY

Systems and methods for unified case management, in some embodiments, include defining a case model, the case model comprising case attributes and a case lifecycle, at a case administration service, defining the case attributes and the case lifecycle, at a case configuration service, managing one or more versions of the case model, at the case administration service, receiving a configuration of the case model and publishing the case model, and at a case application service, deploying an instance of the published case model, including executing the case lifecycle of the published case model, the case lifecycle having a plurality of states, each state comprising one or more steps, executing a step of the case lifecycle, including communicating with at least one external service, performing an operation of the at least one external service, and based on the performance of the operation, modifying at least one of: the state of the case lifecycle or the case attributes.

Embodiments of the present invention also include computer-readable storage media containing sets of instructions to cause one or more processors to perform the methods, variations of the methods, and other operations described herein.

These, and other, aspects of the disclosure will be better appreciated and understood when considered in conjunction with the following description and the accompanying drawings. It should be understood, however, that the following description, while indicating various embodiments of the disclosure and numerous specific details thereof, is given by way of illustration and not of limitation. Many substitutions, modifications, additions and/or rearrangements may be made within the scope of the disclosure without departing from the spirit thereof, and the disclosure includes all such substitutions, modifications, additions and/or rearrangements.

### BRIEF DESCRIPTION OF THE FIGURES

The drawings accompanying and forming part of this specification are included to depict certain aspects of the invention. A clearer impression of the invention, and of the components and operation of systems provided with the invention, will become more readily apparent by referring to the exemplary, and therefore nonlimiting, embodiments illustrated in the drawings, wherein identical reference numerals designate the same components. Note that the features illustrated in the drawings are not necessarily drawn to scale.

FIG. 1 is a flow diagram of one embodiment of a method for case management.

FIG. 2 is a block diagram of one embodiment of a system for case management.

FIG. 3 is a block diagram of one embodiment of a system for case management.

FIG. 4 is a flow diagram of one embodiment of a method for case management.

FIG. 5 is a diagram of one embodiment of a case publishing flow.

FIG. 6 is a diagram of one embodiment of a case publishing process.

### DETAILED DESCRIPTION

The invention and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure the invention in detail. It should be understood, however, that the detailed description and the specific examples, while indicating some embodiments of the invention, are given by way of illustration only and not by way of limitation. Various substitutions, modifications, additions and/or rearrangements within the spirit and/or scope of the underlying inventive concept will become apparent to those skilled in the art from this disclosure.

Before describing embodiments in more detail, some context may prove useful. As discussed, in an enterprise environment, case management systems are used to automate the management of complex sets of documents or other content and associated processes comprising tasks that may be performed. Thus, these case management systems may be utilized with particular efficacy in situations in which the documents or other content that may need to be managed for respective particular instances of a case model may not be the same for each instance and the processing required or selected to be performed may not be the same for each instance.

As discussed above, in these case management systems, a case model typically describes a type of case, instances of which are to be managed by a case management system. A case may be thought of as a way of organizing documents (and, in some instances, the processes that are used to manage those documents). A case model is created at design time to create structure for the case (e.g., model for a set of folders). This structure is then created at runtime for an instance of the case when it is created. For example, the case model definition may include a hierarchical container model portion defining a hierarchical data model representing how case data is organized using a plurality of hierarchically related case nodes.

As opposed to a very structured business process that defines a predetermined workflow that does not vary from instance to instance, using a case model one can model ad hoc actions and define responses thereto with workflows, enabling the processing of respective instances of a case model to be determined dynamically at runtime based, e.g., on events, context data, user input, dynamic evaluation of documents or other content, etc. As a result, each instance of a case model (e.g., the respective loan applications of different applicants or each individual employee) may follow its own course as determined at each step by processing (e.g., that may be defined in applicable portions of the case model). For the purposes of this description, it may be helpful to understand the operation of a case management system. Commonly-owned U.S. patent application Ser. No. 17/402,843, entitled “System and Method for Utilizing Checklists for Lifecycle Management in a Case Management System,” filed on Aug. 16, 2021 describes embodiments of case management systems, and is incorporated herein by reference in their entireties for all purposes.

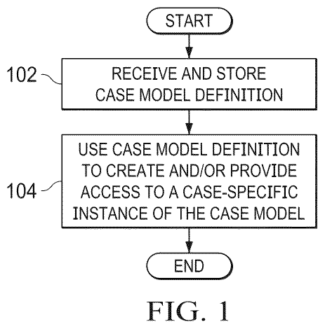

Moving then to FIG. 1, a flow chart illustrating an example embodiment of a process to perform case management is depicted. In the example shown, a case model definition is received and stored (step 102). The case model definition is used to create new instances based on the case model, sometimes referred to herein as “case instances” or “case management instances”, or to provide access to previously-created instances (step 104). For example, a case model may be defined and stored for an employee and an associated process and a loan application and associated processes. Case instances may be created based on the case model and each respective case instance used to manage a corresponding loan application, for example by different respective loan applicants.

Using a case model, one can model ad hoc actions with smaller processes, for example, as opposed to a very structured process that defines an end-to-end workflow. In various embodiments, a case model comprises a hierarchical/nested container model (sometimes referred to herein as a “hierarchical data model”), and may in addition define case roles, case phases (states), or permissions. In some embodiments, permissions may be defined for each case node or level in the hierarchy, and may vary in some embodiments based at least in part on the respective phases (states) of a state machine defined for a case node.

In various embodiments, a case model may include a hierarchical or nested container model. This model represents how the data within a case is organized and what data is captured during runtime. Each node in the hierarchy is sometimes referred to herein as a “case node”. Case nodes at the lowest level of a case model hierarchy may be referred to as “case leaf nodes” or simply “leaf nodes”. “Case leaf nodes” in various embodiments may point to a specific business object or document type.

The term “case role” is used herein to refer to user roles that have been defined in a case model. In various embodiments, users may be assigned to case roles with respect to instances of a case model, and at each case node in the case model permissions may be designated by reference to one or more case roles. During runtime, in some embodiments, members may be added or removed from these roles at case node instances corresponding to respective instances of a type of case as defined in a case model.

In various embodiments, a case model as described herein may be created using a domain-specific or other development module or tool. For example, reusable elements, such sample case nodes typical of those used in the domain (e.g., documents, case roles, behaviors, etc. that may be associated with an employee, loan application process, a new drug approval application, etc.), primitives usable to define a state machine or associated processing for respective case nodes, etc., may be provided. For example, an application programming interface (API) may be defined, or a visual or other case model development tool may be provided.

A case model definition may be embodied in a JSON (JavaScript Object Notation) or other structured data file. A case management system /r platform is provided, which is configured (e.g., by software) to load a case model definition, parse the definition, and create an instance of the case model based on the definition. Instance-specific attributes or state information or other metadata may be stored in a case model instance data store (e.g., a database). At runtime, the case model definition file and the case model instance data for a given instance are used by the case management system to implement the case model instance, including by performing processing and managing case model instance associated content per the case model definition, in light of the current values of the case model instance data for that instance.

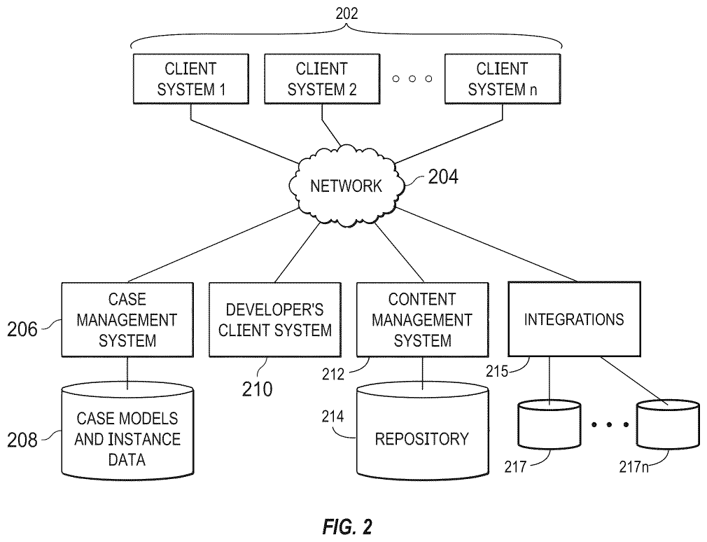

FIG. 2 is a block diagram illustrating an example embodiment of a case management system and environment. In the example shown, client systems 202 are connected via a network 204 (e.g., the Internet, a LAN, a WAN, a wired, cellular or other wireless network, etc.) to a case management system 206. In various embodiments, the case management system 206 may be configured to implement the process of FIG. 1. Case management system 206 uses case models stored in data storage 208 to provide case management services with respect to case management instances, the instance variable data values of which also are stored, in this example, in data storage 208. For example, one or more of clients 202 may connect via network 204 to case management system 206 to obtain access to case management services. For example, case management system 206 may expose a “case management system as a service” (e.g., as a web service) enable clients 202 to connect to case management system 206, create case management instances based on case models stored in data storage 208. The users of client system 202 may be prompted to provide data values or other user input to populate case management instances with metadata, user data, documents, etc., or such other user input as may be required to advance case instances through case management processing as defined in the case model.

In the example shown in FIG. 2, a case model developer system 210 (e.g., a client computer system) also can connect to case management system 206 via network 204. In some embodiments, a case model development user interface or service may be accessed and used to define a case model. For example, a visual or other developer tool may be presented to enable a developer using client system 210 to define a case model and cause the case model to be stored in data storage 208 and deployed by case management system 206. In some embodiments, deployment of a case model includes making the case model available to be used to create case management instances based on the model, and to use the case model to perform with respect to each such instance the case management processing as defined in the case model.

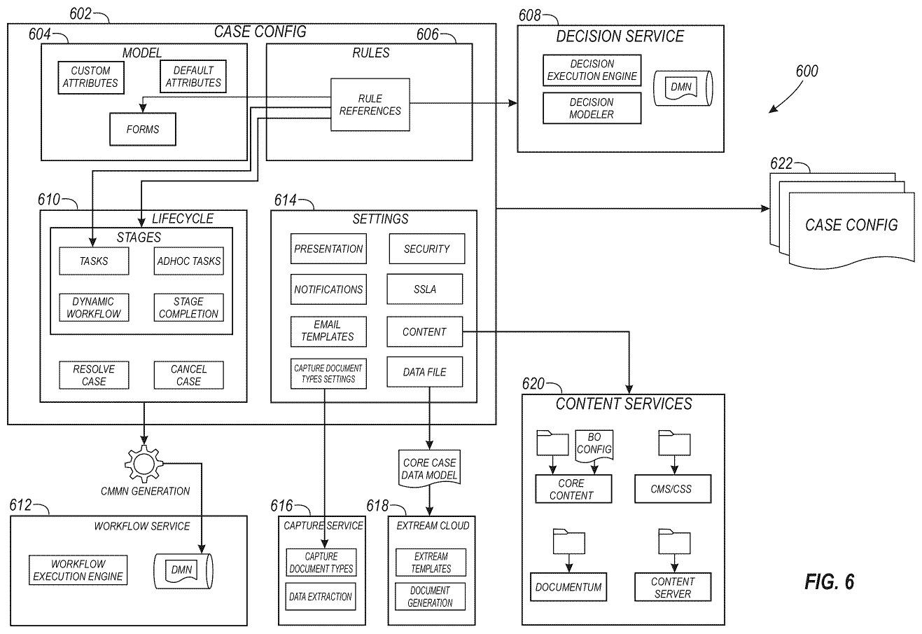

In various embodiments, a case model may indicate one or more content objects to be associated with respective instances of a case model. The case model may include metadata and associated behaviors to enable instance-specific content objects (e.g., documents) to be associated with case leaf nodes of a case instance. In the example shown in FIG. 2, content objects may be accessed via a content management system 212 configured to manage content objects stored in an associated content repository 214. In various embodiments, case management system 206 may be configured to use instance variables associated with a given case instance and metadata or behaviors defined in an associated case model to interact programmatically with content management system 212 to obtain or manage documents or other content objects associated with a case instance. In some embodiments, case management system 206 may be configured, e.g., via the case model, to invoke services or other functionality of content management system 212 with respect to such documents or other content objects. In various embodiments, various integrations 215 may be included (e.g., see the discussion below with respect to FIG. 6). The various integrations or additional capabilities may include items such as capture, document generation, business rules, etc. In some embodiments, each of the integrations can have their own respective repositories (repositories 217 through 217n), with which both the client systems and case management system interact.

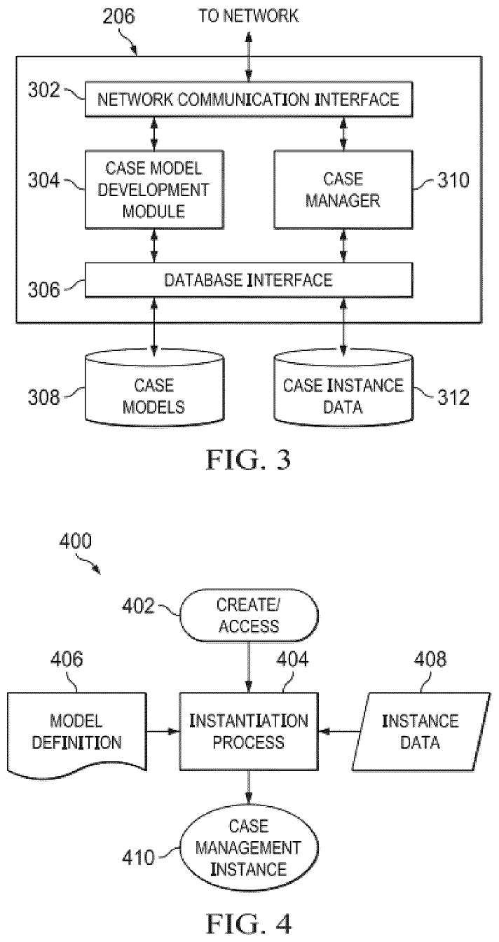

FIG. 3 is a block diagram illustrating an example embodiment of a case management system. In some embodiments, the case management system of FIG. 3 corresponds to case management system 206 of FIG. 2. In the example shown, case management system 206 includes a network communication interface 302, such as a wireless or other network interface card, to provide network connectivity, e.g., to network 204 of FIG. 2. A case model development module 304 is accessible to developers via network communication interface 302 and may be used to create or modify case model definitions. In some embodiments, a visual or other user interface is provided, via network communication interface 302, to enable case models to be created or modified. For example, a developer may use a browser to access the developer user interface in some embodiments. A developer, as referred to herein may be, for example, a business analyst (or other user). Case model definitions are stored by case model development module 304 by using a backend database (or other data storage) interface 306 to store the case model(s) in case model store 308.

Referring further to FIG. 3, the case management system 206 includes a case management module 310. In various embodiments, case management module 310 includes functionality to enable users, e.g., users of client systems 202 of FIG. 2, to create or use case management instances based on case models stored in case model store 308. Case management module 310, for example, may expose a web or other interface to remote users and may receive via said interface a request to create or access a case instance. Case management module 310 uses database interface 306 to obtain an associated case model definition from case model store 308, to use the case model to instantiate case instances. Instance variables are stored by case management module 310 in case instance data store 312.

FIG. 4 is a diagram illustrating an example embodiment of a process and system to create or provide access to case management instances. In some embodiments, the process of FIG. 4 may be implemented by a case management system or a component thereof, such as case manager 310 of FIG. 3. In the example shown, case management system 400 receives a request 402 to create or access a case management instance and invokes instantiation process 404. Instantiation process 404 uses a case model definition 406 associated with the request, e.g., a case model indicated explicitly or otherwise associated with data comprising the request 402, and case management instance data 408 associated with the case management instance, to instantiate and provide access to a case management instance 410.

In various embodiments, a case model definition such as model definition 406 may include a JSON file or other structured data, which the case management system is configured to parse and use to construct case instances based on the case model. For example, the hierarchical data structure may be defined, along with metadata and associated behaviors for each case node. A case management instance, such as case management instance 410, may include an in-memory instance of a data structure defined in case model definition 406, which is used to store instance variables, such as instance data 408 in this example.

As can be seen then, using a case model one can model ad hoc actions and define responses thereto, enabling the processing of respective instances of a case model to be determined dynamically at runtime based, e.g., on events, context data, user input, dynamic evaluation of documents or other content, etc. As a result, each instance of a case model (e.g., the respective loan applications of different applicants or each individual employee) may follow its own course as determined at each step by processing (e.g., that may be defined in applicable portions of the case model).

In some embodiments, a no-code integrated and unified case management workspace is provided. As is discussed below, this disclosure focuses on how a knowledge worker can bring various aspects into the workspace. In some embodiments, a no-code case app builder provides a no-code SaaS solution that allows business analysts (or other users) to build end-to-end tailored case apps using several utilities and productivity tools. Exemplary embodiments include two modules. First, an admin module is used to configure case applications targeting business administrators. Second, an application module is used to create, process and manage case instances targeting knowledge workers and managers.

Following are examples of innovations and the building blocks that are useful in building case apps using the disclosed solutions.
Case modeling with several no-code modelers and visual configurations.
Publishing process to create a Config that acts as a single source of truth to drive the runtime.
Auto generating a unified and integrated workspace for knowledge workers to process end to end cases leveraging services and application such as the “OpenText Core Ecosystem,” which is a suite of cloud-based content services and applications designed to enhance collaboration, productivity, and content management.
Using a public API to enable customers build their own custom and domain specific self-service portal to initiate cases or using plain API's to create an API as part of their existing business processes.

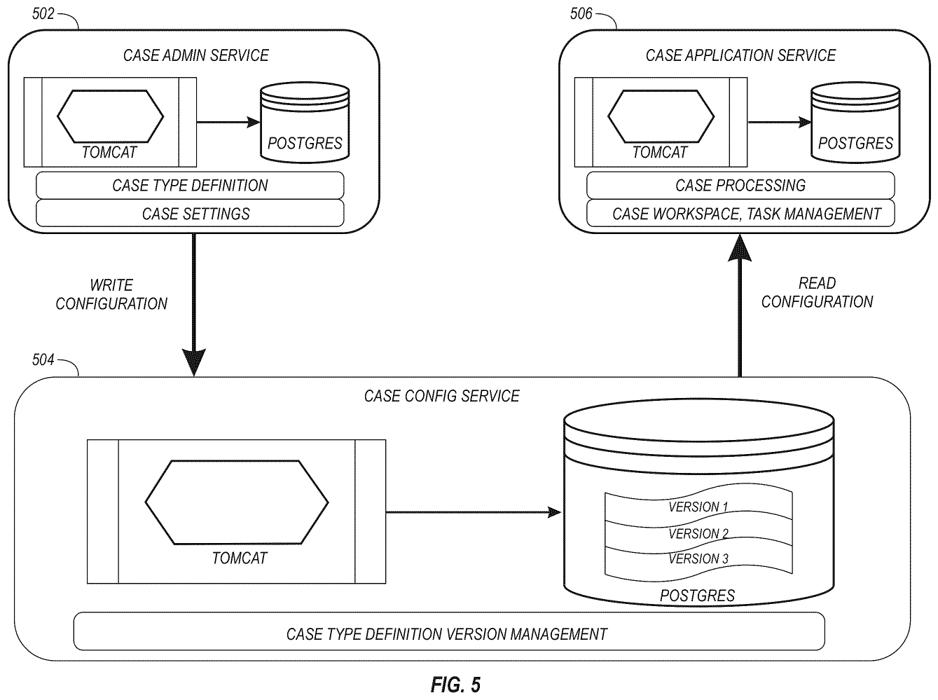

In some embodiments, different services can be seamlessly incorporated, for example, customer experience management services. As also discussed below, any desired services are generated automatically, auto-provisioned, and no coding is required by a user. For example, services required for auto-provisioning include: Case User Interface (UI) services, Admin services, Config services, Runtime services, Reports services, Notifications services, etc. In some examples, an admin service creates default attributes of a case model in an admin database, and can also update tasks, attributes, and rules (i.e., refining the case model). Case publishing involves taking case model data and publishing into a Config service (discussed below with respect to FIG. 5). The case may then be processed and updated. In some embodiments, the UI has a task manager widget and a case creation widget. The Config service saves different versions of the case, each of which are “read only”. The case application can support the different versions. This creates a JSON file called the case management modeling notation (CMMN) which is stored in a Workflow service (see FIG. 6, discussed below).

In some embodiments, a case management system can provide numerous key case services, such as Case UI (Front End), Admin (Case modeling), Runtime (Case processing), Config (Case versioning), Reports (Supports reports), Notification (Enables notification delivery), etc. Other services can also be provided or enabled. In one example, a case admin user can interface with the Case UI to create and publish a case model. A case worker can interface with the Case UI to create a case instance and access reports, for example.

Following is one example of a case model creation process. First, a case admin user accesses the application and creates a case type. Internally, a case admin service creates default attributes, creation form, email templates for outbound communications, configures default notifications settings, system and functional roles with required capabilities mapped to users, default content management, etc., which can be stored in a case admin database. A user can refine the case model. Add/update stages, tasks, custom attributes, rules, etc. can also be stored in the case admin database. Finally, the case model is ready to be published for end users to create case instances.

Generally, as discussed above, case publishing involves taking case model data and publishing into a Config service, where it may then be processed and updated. FIG. 5 is a diagram of one embodiment of a case publishing flow. FIG. 5 shows three services, a case admin service 502, a case config service 504, and a case application service 506. The case admin service 502 includes a web server or servlet container (labeled “Tomcat” in FIG. 5) and a database (e.g., a PostgreSQL object-relational database management system) (labeled “Postgres” in FIG. 5). FIG. 5 also shows case type definitions and case settings with the case admin service 502. The case config service 504 includes a web server or servlet container (labeled “Tomcat” in FIG. 5) and a database (e.g., a PostgreSQL object-relational database management system) (labeled “Postgres” in FIG. 5). The database may store various versions of case type definitions. FIG. 5 also shows case type definition version management with the case config service 504. The case application service 506 includes a web server or servlet container (labeled “Tomcat” in FIG. 5) and a database (e.g., a PostgreSQL object-relational database management system) (labeled “Postgres” in FIG. 5). FIG. 5 also shows case processing and case workspace, task management with the case application service 506.

As discussed above, a user defines a case model, including case attributes and a case lifecycle. Defining a case model may involve a user sending a write instruction to the case configuration service 504 and, in response, at the case configuration service 504, writing the case model to a case model repository. Defining a case also may include storing the case definition in one repository and then transforming the case definition into a versioned case model using a config service when published. Note a difference between two case models - a raw case model or definition that is created by a business analyst in the admin module and a consumable/refined case model by the application when the definition is published. The case attributes and the case lifecycle are defined at the case admin service 502. The case configuration service 504 manages one or more versions of the case model. The case application service 506 receives, for each case model, configuration of the case models and publishes the case models. The case application service 506 then sends a read instruction to the case configuration service 504, and in response, the case configuration service 504 reads the case model from the case model repository, and sends the case model to the case application service 506. The case application service 506 also deploys an instance of the published case models.

In some embodiments, the deployment of an instance of a published case model involves several steps. A first step involves executing the case lifecycle of the published case model. The case lifecycle can have one or more states, each of which include one or more steps. A second step involves executing steps of the case lifecycle. As an example, following are steps involved with the execution of a step of a case lifecycle. A first step is communicating with at least one external service. A second step is performing an operation of the respective external service. A third step is, based on the performance of the operation, modifying one or more of the state of the case lifecycle or the case attributes.

In some embodiments, a case workspace can be defined. The case workspace may be comprised of one or a plurality of case workspaces, each of which may be based on the published case model. A case workspace may comprise, for example, the instance of the published case model and a themed user interface. As an example, in some embodiments, the themed user interface can comprise a form for inputting case attributes. When communicating with the external service (discussed above), the communication can be based on an interaction with the themed user interface. In some embodiments, the case configuration service 504 may generate a reference to each of the external services, and the communications with the external services at the case application service 506 is based on the generated reference to each of the external services.

When a case model is updated, in some embodiments, the case administration service 502 receives an instruction to update the case model. The case configuration service 504 then, based on the received instruction, updates the case model. Finally, the case application service 506, republishes the updated case model, including updating the instance of the case model deployed for each case workspace.

FIG. 6 is a diagram of one embodiment of a case publishing process 600 for publishing Case Config 622. The config service (discussed above) generally handles the items within a case config block 602. The model section 604 includes custom attributes, default attributes, and forms. Rule references are shown in the Rules section 606. In some embodiments, the rule definitions are stored as a DMN (decision model and notation) in a storage location in the decision service 608. A decision modeler is used to model the rules. These rules will be referenced in the forms (in model section 604) and in the lifecycle section 610. The execution of the rules happens in the decision service 608.

The lifecycle section 610 comprises stages (in this example: Tasks, Adhoc Tasks, Dynamic Workflow, Stage Completion), Resolved Case, and Cancel Case, which are each actions that can be performed in a lifecycle. These items are auto-provisioned whenever a case is published. When a case type is published, a case management modeling notation (CMMN) is generated and is deployed into the workflow service 612 as a CMMN. The case config block 602 also includes settings section 614, which includes various items, including Presentation, Security, Notifications, SLA, Email Templates, Content, Capture Document Type Settings, and Data File. The settings section 614 provides information to various other components, including Capture service 616, Exstream cloud 618, and Content services 620.

Although the invention has been described with respect to specific embodiments thereof, these embodiments are merely illustrative, and not restrictive of the invention as a whole. Rather, the description is intended to describe illustrative embodiments, features and functions in order to provide a person of ordinary skill in the art context to understand the invention without limiting the invention to any particularly described embodiment, feature or function, including any such embodiment feature or function described in the Abstract or Summary. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention.

Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Software implementing embodiments disclosed herein may be implemented in suitable computer-executable instructions that may reside on a computer-readable storage medium. Within this disclosure, the term “computer-readable storage medium” encompasses all types of data storage medium that can be read by a processor. Examples of computer-readable storage media can include, but are not limited to, volatile and non-volatile computer memories and storage devices such as random access memories, read-only memories, hard drives, data cartridges, direct access storage device arrays, magnetic tapes, floppy diskettes, flash memory drives, optical data storage devices, compact-disc read-only memories, hosted or cloud-based storage, and other appropriate computer memories and data storage devices.

Those skilled in the relevant art will appreciate that the invention can be implemented or practiced with other computer system configurations including, without limitation, multi-processor systems, network devices, mini-computers, mainframe computers, data processors, and the like. The invention can be employed in distributed computing environments, where tasks or modules are performed by remote processing devices, which are linked through a communications network such as a LAN, WAN, and/or the Internet. In a distributed computing environment, program modules or subroutines may be located in both local and remote memory storage devices. These program modules or subroutines may, for example, be stored or distributed on computer-readable media, including magnetic and optically readable and removable computer discs, stored as firmware in chips, as well as distributed electronically over the Internet or over other networks (including wireless networks).

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention. At least portions of the functionalities or processes described herein can be implemented in suitable computer-executable instructions. The computer-executable instructions may reside on a computer readable medium, hardware circuitry or the like, or any combination thereof.

Any suitable programming language can be used to implement the routines, methods or programs of embodiments of the invention described herein, including C, C++, Java, JavaScript, HTML, or any other programming or scripting code, etc. Different programming techniques can be employed such as procedural or object oriented. Other software/hardware/network architectures may be used. Communications between computers implementing embodiments can be accomplished using any electronic, optical, radio frequency signals, or other suitable methods and tools of communication in compliance with known network protocols.

As one skilled in the art can appreciate, a computer program product implementing an embodiment disclosed herein may comprise a non-transitory computer readable medium storing computer instructions executable by one or more processors in a computing environment. The computer readable medium can be, by way of example only but not by limitation, an electronic, magnetic, optical or other machine readable medium. Examples of non-transitory computer-readable media can include random access memories, read-only memories, hard drives, data cartridges, magnetic tapes, floppy diskettes, flash memory drives, optical data storage devices, compact-disc read-only memories, and other appropriate computer memories and data storage devices.

Particular routines can execute on a single processor or multiple processors. Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. Functions, routines, methods, steps and operations described herein can be performed in hardware, software, firmware or any combination thereof.

It will also be appreciated that one or more of the elements depicted in the drawings/figures can be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present), and B is false (or not present), A is false (or not present) and B is true (or present), and both A and B are true (or present). As used herein, a term preceded by “a” or “an” (and “the” when antecedent basis is “a” or “an”) includes both singular and plural of such term, unless clearly indicated within the claim otherwise (i.e., that the reference “a”or “an”clearly indicates only the singular or only the plural).

Also, as used in the description herein and throughout the meaning of “in” includes “in” and “on” unless the context clearly dictates otherwise.

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Language designating such nonlimiting examples and illustrations includes, but is not limited to: “for example,” “for instance,” “e.g.,” “in one embodiment.”

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

Generally, then, although the invention has been described with respect to specific embodiments thereof, these embodiments are merely illustrative, and not restrictive of the invention. Rather, the description is intended to describe illustrative embodiments, features and functions in order to provide a person of ordinary skill in the art context to understand the invention without limiting the invention to any particularly described embodiment, feature or function, including any such embodiment feature or function described. While specific embodiments of, and examples for, the invention are described herein for illustrative purposes only, various equivalent modifications are possible within the spirit and scope of the invention, as those skilled in the relevant art will recognize and appreciate.

As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

What is claimed is:

1. A method for unified case management, comprising:
defining a case model, the case model comprising case attributes and a case lifecycle;
at a case administration service, defining the case attributes and the case lifecycle;
at a case configuration service, managing one or more versions of the case model;
at the case administration service, receiving a configuration of the case model and publishing the case model; and
at a case application service, deploying an instance of the published case model, comprising:
executing the case lifecycle of the published case model, the case lifecycle having a plurality of states, each state comprising one or more steps;
executing a step of the case lifecycle, comprising:
communicating with at least one external service;
performing an operation of the at least one external service; and
based on the performance of the operation, modifying at least one of: the state of the case lifecycle or the case attributes.

2. The method of claim 1, wherein:
said defining the case model comprises:
sending a write instruction to the case configuration service and, in response, at the case configuration service, writing the case model to a case model repository; and
said receiving a configuration of the case model comprises, at the case application service, sending a read instruction to the case configuration service and, in response, at the case configuration service, reading the case model from the case model repository and sending the case model to the case application service.

3. The method of claim 1, further comprising:
defining a case workspace, the case workspace comprising the instance of the published case model, the case workspace comprising a themed user interface; and
said communicating with at least one external service is based on an interaction with the themed user interface.

4. The method of claim 3, wherein the case workspace is a plurality of case workspaces, each of the case workspaces based on the published case model.

5. The method of claim 3, further comprising:
at the case administration service, receiving an instruction to update the case model;
at the case configuration service, based on the received instruction, updating the case model; and
at the case application service, republishing the updated case model comprising updating the instance of the case model deployed for each case workspace.

6. The method of claim 3, wherein the themed user interface comprises a form for inputting case attributes.

7. The method of claim 6, further comprising:
at the case configuration service, generating a reference to each one of the at least one external service, wherein at the case application service, said communicating with at least one external service is based on the generated reference to each one of the at least one external service.

8. A system for unified case management, comprising:
a processor;
a non-transitory computer readable medium, comprising instructions for:
defining a case model, the case model comprising case attributes and a case lifecycle;
at a case administration service, defining the case attributes and the case lifecycle;
at a case configuration service, managing one or more versions of the case model;
at the case administration service, receiving a configuration of the case model and publishing the case model; and
at a case application service, deploying an instance of the published case model, comprising:
executing the case lifecycle of the published case model, the case lifecycle having a plurality of states, each state comprising one or more steps;
executing a step of the case lifecycle, comprising:
communicating with at least one external service;
performing an operation of the at least one external service; and
based on the performance of the operation, modifying at least one of: the state of the case lifecycle or the case attributes.

9. The system of claim 8, wherein:
said defining the case model comprises:
sending a write instruction to the case configuration service and, in response, at the case configuration service, writing the case model to a case model repository; and
said receiving a configuration of the case model comprises, at the case application service, sending a read instruction to the case configuration service and, in response, at the case configuration service, reading the case model from the case model repository and sending the case model to the case application service.

10. The system of claim 8, further comprising:
defining a case workspace, the case workspace comprising the instance of the published case model, the case workspace comprising a themed user interface; and
said communicating with at least one external service is based on an interaction with the themed user interface.

11. The system of claim 10, wherein the case workspace is a plurality of case workspaces, each of the case workspaces based on the published case model.

12. The system of claim 10, further comprising:
at the case administration service, receiving an instruction to update the case model;
at the case configuration service, based on the received instruction, updating the case model; and
at the case application service, republishing the updated case model comprising updating the instance of the case model deployed for each case workspace.

13. The system of claim 10, wherein the themed user interface comprises a form for inputting case attributes.

14. The method of claim 13, further comprising:
at the case configuration service, generating a reference to each one of the at least one external service, wherein at the case application service, said communicating with at least one external service is based on the generated reference to each one of the at least one external service.

15. A computer program product comprising a non-transitory computer readable medium storing instructions translatable by a processor, the instructions when translated by the processor perform, in a unified case management environment:
defining a case model, the case model comprising case attributes and a case lifecycle;
at a case administration service, defining the case attributes and the case lifecycle;
at a case configuration service, managing one or more versions of the case model;
at the case administration service, receiving a configuration of the case model and publishing the case model; and
at a case application service, deploying an instance of the published case model, comprising:
executing the case lifecycle of the published case model, the case lifecycle having a plurality of states, each state comprising one or more steps;
executing a step of the case lifecycle, comprising:
communicating with at least one external service;
performing an operation of the at least one external service; and
based on the performance of the operation, modifying at least one of: the state of the case lifecycle or the case attributes.

16. The computer program product of claim 15, wherein:
said defining the case model comprises:
sending a write instruction to the case configuration service and, in response, at the case configuration service, writing the case model to a case model repository; and
said receiving a configuration of the case model comprises, at the case application service, sending a read instruction to the case configuration service and, in response, at the case configuration service, reading the case model from the case model repository and sending the case model to the case application service.

17. The computer program product of claim 15, further comprising:
defining a case workspace, the case workspace comprising the instance of the published case model, the case workspace comprising a themed user interface; and
said communicating with at least one external service is based on an interaction with the themed user interface.

18. The computer program product of claim 17, wherein the case workspace is a plurality of case workspaces, each of the case workspaces based on the published case model.

19. The computer program product of claim 17, further comprising:
at the case administration service, receiving an instruction to update the case model;
at the case configuration service, based on the received instruction, updating the case model; and
at the case application service, republishing the updated case model comprising updating the instance of the case model deployed for each case workspace.

20. The computer program product of claim 17, wherein the themed user interface comprises a form for inputting case attributes.
